(19) United States
(12) Patent Application Publication
(10) Pub. No.: US 2025/0339982 A1
(43) Pub. Date: Nov. 6, 2025

(54) Professional Home Haircuts

(71) Applicant: Stanley Williams, Pittsburgh, PA (US)

(72) Inventor: Stanley Williams, Pittsburgh, PA (US)

(21) Appl. No.: 18/652,533

(22) Filed: May 1, 2024

(51) Int. Cl. B26B 19/38; A45D 44/00

(52) U.S. Cl. CPC B26B 19/388; A45D 44/005

(57) ABSTRACT

Automated hair cut devices and methods are provided for seamlessly integrating a digital controller and automated hair cutting tools into the haircutting process, which empowers individuals to effortlessly select and receive precise haircuts within the comfort of their homes, eliminating the need for salon visits, wait times, and associated costs. By providing a cost-effective, convenient, and efficient solution, this invention fundamentally transforms the traditional approach to haircare.

### CROSS-REFERENCE TO RELATED APPLICATIONS

This application claims the benefit of U.S. Provisional Application No. 63/610,033, filed on Dec. 14, 2023, the entire contents of which are incorporated herein by reference.

### FIELD OF THE INVENTION

The invention relates to hair cutting devices and methods.

### BACKGROUND OF THE INVENTION

The invention pertains to the field of haircare and, more specifically, addresses the application of digital technology to revolutionize the process of administering haircuts for both men and women. It aims to eliminate the inconveniences associated with traditional haircutting methods and provide individuals with a convenient, efficient, and cost-effective solution to receive accurate haircuts within the comfort of their homes.

Traditionally, obtaining a haircut has involved leaving one's residence, travelling to a barber or salon, enduring wait times, receiving a haircut service, paying for the service, and then proceeding to the next destination. This conventional process consumes significant time and financial resources, often causing inconvenience for individuals.

Haircuts have been administered using manual techniques involving a comb and a pair of scissors. This approach necessitates the use of both hands, resulting in time-consuming processes and the potential for uneven haircuts. Furthermore, conventional haircutting tools, such as combs and scissors, lack flexibility and hinder the creation of stylish and intricate haircuts.

The present subject matter seeks to depart from these traditional practices. It leverages the power of digital technology to simplify and expedite the haircutting process. By eliminating the need for manual intervention, this innovation offers swift, precise, and readily accessible haircuts at home, effectively addressing the limitations associated with conventional methods.

### SUMMARY OF THE INVENTION

The present subject matter is designed to address the inherent challenges of traditional haircutting methods. It introduces a paradigm shift by incorporating advanced digital technology into the process, allowing individuals to receive haircuts swiftly, accurately, and conveniently within the confines of their homes. This innovative solution negates the necessity for salon appointments, waiting in queues, and the associated expenditure.

The core of this invention is a unique device that seamlessly integrates cutting-edge digital technology. Users gain access to a diverse array of haircut styles through a user-friendly interface displayed on a screen. Upon selecting their preferred haircut style, the device operates autonomously to deliver precise and accurate haircuts. In certain embodiments, this service is provided free of charge, after the purchase of the device, and it eliminates the need for external salon visits, resulting in significant time and cost savings for users.

The present subject matter introduces several novel concepts that fundamentally transform the traditional approach to haircare. This invention stands out by integrating advanced digital technology, enabling users to select and receive haircuts in a streamlined manner. By eliminating the need for salon appointments and associated fees, the invention offers a highly cost-effective solution to haircare needs.

The present subject matter comprises of a plurality of tools, including automated (e.g., which may include an appropriately sized robotic arm) electric razor blades, clippers, sensors, a comb, a brush, and/or an out liner trimmer. The electric razor blades range from 0.0 mm to 10 mm in length. The automated tools are attached to the hood and can move to affect the haircut selected within the hood using hardware (e.g., a track attached to the inside of the hood, a robotic arm that can move around the user's head).

Users can enjoy haircuts within the comfort of their homes, bypassing the inconveniences of travel and waiting times. The device guarantees precise and accurate haircuts, enhancing the overall quality of the user experience. With no waiting periods or commuting required, users benefit from substantial time savings.

In preferred embodiments, a device is provided with a controller (e.g., digital, automatic, software) comprising a computer processor, a graphical user interface (e.g., an interactive touchscreen), the capability to access a database, and at least one autonomous cutting algorithm, which are in communication with one another. The graphical user interface presents a user with a selection of haircut styles. Once selected, one or more automated hair cutting devices (e.g., tools) that are directed by the controller (e.g., using the autonomous cutting algorithm) then perform the selected haircut. The controller is further integrated with the graphical user interface to permit the user to adjust the haircut parameters (e.g., length of hair on a particular portion of the head) in real time to achieve precise and accurate results.

The invention also comprises a method of cutting a user's haircut using the devices described above. In these methods, the user selects a haircut, the user puts their head in the hood, and the controller working with the sensor, the autonomous cutting algorithm module, and an automated hair cutting tool cuts the user's hair according to the selection.

In the most preferred embodiments, hair cutting devices for a user to use to cut the user's hair are provided. The hair cutting devices comprise a controller comprising a plurality of modules, which may be stored in the device or in the device and in other locations (e.g., a server associated with a website, a self-contained computer). The modules can be separate, or combined, or split into parts that can communicate with one another. The plurality of modules comprises a computer processor module, a graphical user interface module, a database module that provides access to a database, and at least one autonomous cutting algorithm module. Some or all of these modules are in communication with one another. The graphical user interface module provides images of a plurality of haircut types to the user, one of which the user can select. Each of these haircut types shown in images are associated with data in the database module.

These most preferred embodiments also comprise a hood comprising one or more of the controller modules, at least one sensor that senses at least one dimension of the user's head, a plurality of holes through which hair can be drawn (e.g., by vacuum, as in the Flowbee devices that were sold, or the vacuum/scissor haircuts on the Skylap space station) and cut, and at least one automated hair cutting tool that is controlled by the autonomous cutting algorithm module and the computer processor module accessing the database module. The one or more automated hair cutting tools are attached to the hood by hardware (e.g., a metal track attached to the hood on which the automated tools (e.g., robotic arms operating cutting tools) can move around the hood as necessary) that permits the tools to move about the hood in response to the autonomous cutting algorithm module. The hood may have particular hardware for each tool used.

In these most preferred embodiments, the controller directs the autonomous cutting algorithm module to use the automated hair cutting tool and the sensor to obtain the haircut type selected by the user.

In addition to the above, the graphical user interface module may be provided at least in part on an internet website or a self-contained computer. In some embodiments, the haircut types comprise men's haircut types and women's haircut types. In some embodiments, the plurality of holes in the hood are from a size of about 1 mm to about 5 mm, and in others from about 0.5 mm to about 9 mm. In different embodiments of these, the automated hair cutting tool comprises an electric clipper, an out liner trimmer, electric razor blades, or a pair of scissors.

In the most preferred of these embodiments, the user can stop the controller at any time and make adjustments (e.g., length of hair) to the haircut that is obtained.

The most preferred embodiments of this invention also comprise methods for cutting a user's hair. These methods comprise: (a) selecting a haircut type from a plurality of haircut type images on a graphical user interface; (b) placing the user's head into the hood of a device; (c) conforming the selected haircut type to the dimensions of the user's head using at least one sensor in the hood; and (d) cutting the user's hair in the hood using at least one automated hair cutting tool attached to the hood and operated by a controller comprising an autonomous cutting algorithm module.

In certain embodiments of these methods, the graphical user interface module is provided at least in part on an internet website or a self-contained computer. In some of these embodiments the haircut types comprise men's haircut types and women's haircut types. In some of these embodiments, the hair cutting tool comprises an automated electric clipper, an out liner trimmer, electric razor blades, or a pair of scissors.

In the most preferred embodiments of these methods, the user can stop the controller at any time and make adjustments to the haircut that is obtained.

The devices and methods can be used in the confines of a user's home, eliminating the need for a salon appointment and travel. The device can also be used by men or women. The device can also be adjusted and/or adapted to diverse hair types, lengths, and styles, wet or dry, etc.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 shows a perspective view of an embodiment of an automated hair cut device of this invention.

### DETAILED DESCRIPTION OF THE INVENTION

The invention provides automated hair cutting devices and methods.

In certain embodiments of this invention a mechanical device is provided that is controlled in part by digital technology (referred to herein as “controller”). The controllers comprise digital, automatic, software, and a processor, a graphical user interface (e.g., an interactive touchscreen), the capability to access a database, and at least one autonomous cutting algorithm. The controller may have other functions and hardware. The controllers in some embodiments comprise modules that can all exist on a device or be provided in modules that communicate with one another on an internet website, a self-contained computer, and/or in the device.

In preferred embodiments, an internet website is provided that comprises a display of a plurality of haircuts (e.g., an undercut, a Caesar cut, a crew cut, a fade, bob's, layers, bangs, pixie, bun, etc.) that the automated hair cutting devices and methods of this invention can provide to a user. A user can make selections of which haircut is desired from those displayed using a graphical user interface and the controller. The website/controller then records the selection made. The website display can be updated with new types of haircuts, or refinements to previously displayed haircuts using the controller.

In alternative embodiments, these same capabilities can be provided on a self-contained computer, such as a mobile phone, a tablet, a laptop computer, a desktop computer, etc. This self-contained computer can communicate with a server in some embodiments for updates as described for the website embodiment above. The self-contained computer embodiments can also record the selection made of which haircut the user desires, and is in communication with the controller.

In certain preferred embodiments, the graphical interface is interactive (e.g., a touchscreen).

In preferred embodiments, each haircut that can be provided by the devices and methods of this invention is associated with a data file containing the parameters of the haircut, including the length of hair at different locations on a head, a type of cut of the hair, etc., all of which obtain the desired look of the haircut. These data files can be updated with new types of haircuts, and, in some embodiments, with personalized information concerning a user and/or a repeat user, so that the haircut is tailored to them in particular. The data files are part of and/or accessible to the controller.

In these embodiments, the data files are stored either in the device itself, in a first embodiment, on a server in communication with the internet website, in a second embodiment (or on the self-contained computer embodiments). These data files can be updated with new types of haircuts, or refinements to previously stored haircut data, or with information personalized to certain repeat users, in some embodiments, using the controller.

In these preferred embodiments, using the controller, the devices of this invention can communicate with the internet website (or with a self-contained computer's memory) and obtain the selection of the haircut that the user made. The selection is then matched with a data file pertaining to the haircut selection. This data file is then accessed from the device itself in the first embodiment, where it is stored in the device itself, or accessed from the internet, in the second embodiment (or a self-contained computer embodiment), where the data file is not stored in the device.

In these embodiments, using the controller, an autonomous cutting algorithm uses the data file and information concerning the user and performs the haircut. Safety measures are taken (e.g., sensors calculate the distance the hair is from the scalp so as not to harm the scalp). In preferred embodiments of these, the process can be adjusted in real time according to a user's selections on the graphical user interface to obtain the desired results (e.g., shorter, changes to different locations).

In these embodiments, the user then places their head into the device of this invention, which conforms itself to the size and shape of the user's head and/or otherwise records the size and shape of the user's head. The data file is then applied to the dimensions of the user's head to obtain the haircut desired. Using the graphical user interface, the user can make real time changes to the cutting to make the desired result.

In particularly preferred embodiments of this invention, one or more robotic arms are adapted to fit into and attached to a hood, and in conjunction with sensors, autonomously operate at least one automated hair cutting tool (and more preferably more than one such tool) operated by a controller comprising an autonomous cutting algorithm module. Such robotic arms and sensors are available for sale (e.g., VenHub, etc.) and can be purchased and adapted to this invention or otherwise fabricated by a person of skill in the art. In certain of these embodiments, the robotic-operated tools use artificial intelligence to train, improve and operate the device to perform the cutting operations.

In embodiments that use a robotic arm, the arm operates the hair cutting tools and moves them to the correct locations to cut and/or otherwise style the hair, following the direction of the controller and the hair cut selection that was made. At least one sensor works with the arm to determine the different surfaces of the hair versus the skin to provide safe and accurate hair cuts without damaging the skin.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

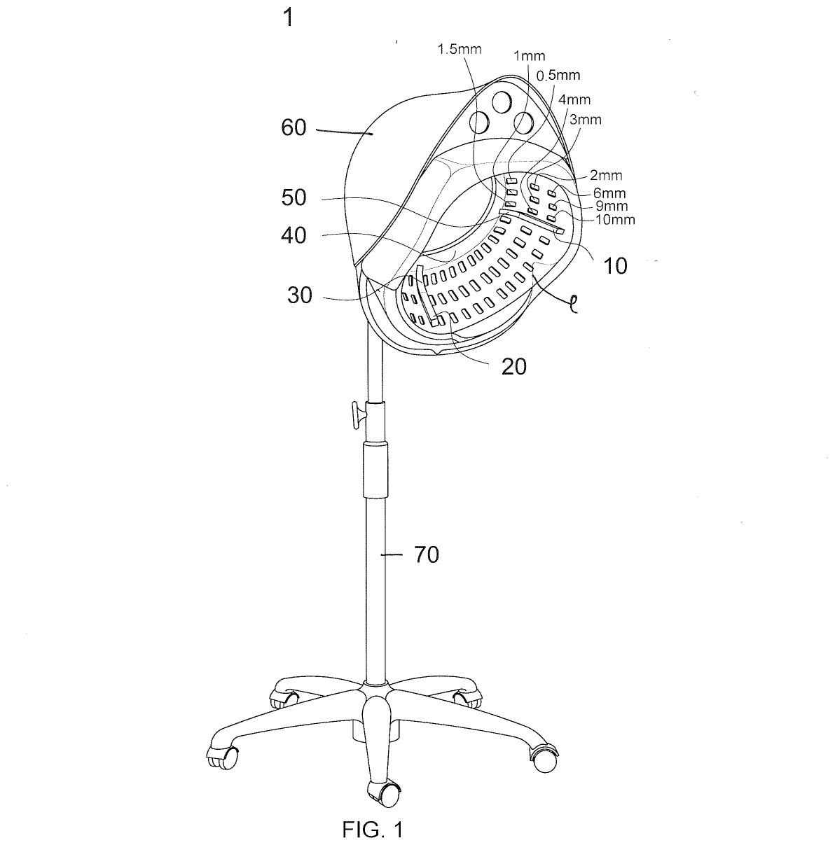

FIG. 1 shows a schematic of an embodiment of a device of this invention 1. A hood 60 contains a controller (or modules of such, not shown) and a 110 voltage plug (also not shown). The hood also contains a number of different size holes (e.g., 0.5 mm to 10 mm) that are used to, in part, obtain the particular haircut selected by the user. Each hole lets in a certain amount of hair. In some embodiments, a vacuum is applied to pull the hair through the hole before it is cut or otherwise processed. Also shown in this example are an automated clipper 10, an out liner trimmer 20, a pair of scissors 30, a sensor 40 (to detect the size, shape and/or location of the head), and a hair comb 50. Other automated haircut tools (e.g., cutting devices, electric razors, brushes) can also be used, as will be apparent to a person of skill in the art. In this embodiment, the hood 60 is attached to a stand 70 that is adjustable to conform to the user and/or a chair that the user sits in for the hair cut. Table top or counter top models can also be used where the hood 60 attaches to a shorter stand (or table, or wall, etc.) for those applications.

In operation, the user goes on to an internet website associated with the device 1 (or selects it from a self-contained computer in some embodiments) and selects a haircut that is desired. The controller of this invention then identifies a data file which is then accessed that is associated with that haircut. Using one or more devices, such as sensors 40, the device controller conforms the data file information to the dimensions of the user's hair and head, and using one or more automated hair cut tools (e.g., clipper 10, out liner trimmer 20, scissors 30, hair comb 50), the device 1 performs the haircut.

In certain preferred embodiments, using the controller of this invention, the user can stop the hair cut process (or wait until it is finished) and make additional selections after inspecting the cut (e.g., cutting the hair shorter, taking the trim higher, etc.). Thus, in these embodiments, real time monitoring and adjustments can be made to achieve precise and accurate cuts. These additional selections can be provided by the controllers of this invention on the internet website graphical user interface or on the self-contained computer, depending on the embodiment. The finished result can then be saved by the controller, and, in some embodiments, a data file saved of what transpired, so that the user can obtain the same haircut in the future.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A hair cutting device for a user to use to cut the user's hair, the hair cutting device comprising:
a. a controller comprising a plurality of modules, the plurality of modules comprising a computer processor module, a graphical user interface module, a database module that provides access to data in a database, and at least one autonomous cutting algorithm module, which modules are in communication with one another, and wherein the graphical user interface module provides images of a plurality of haircut types to the user, one of which the user can select, which images are associated with data in the database module;
b. a hood comprising one or more of the controller modules, at least one sensor that senses at least one dimension of the user's head, a plurality of holes through which hair can be drawn and cut, and at least one automated hair cutting tool that is controlled by the autonomous cutting algorithm module and the computer processor module accessing the database module; and
c. wherein the controller directs the autonomous cutting algorithm module to use the automated hair cutting tool and the sensor to obtain the haircut type selected by the user.

2. A hair cutting device of claim 1 wherein the graphical user interface module is provided at least in part on an internet website or a self-contained computer.

3. A hair cutting device of claim 1 wherein the haircut types comprise men's haircut types and women's hair cut types.

4. A hair cutting device of claim 1, wherein the plurality of holes in the hood are from a size of about 1 mm to about 5 mm.

5. A hair cutting device of claim 1 wherein the automated hair cutting tool comprises an electric clipper, an out liner trimmer, electric razor blades, or a pair of scissors.

6. The hair cutting device of claim 1 wherein the user can stop the controller at any time and make adjustments to the haircut that is obtained.

7. A method for cutting a user's hair, the method comprising:
a. selecting a haircut type from a plurality of haircut type images on a graphical user interface;
b. placing the user's head into the hood of a device;
c. conforming the selected haircut type to the dimensions of the user's head using at least one sensor in the hood; and
d. cutting the user's hair in the hood using at least one automated hair cutting tool operated by a controller comprising an autonomous cutting algorithm module.

8. The method of claim 7 wherein the graphical user interface module is provided at least in part on an internet website or a self-contained computer.

9. The method of claim 7 wherein the haircut types comprise men's haircut types and women's hair cut types.

10. The method of claim 7 wherein the automated hair cutting tool comprises an electric clipper, an out liner trimmer, electric razor blades, or a pair scissors.

11. The method of claim 7 wherein the user can stop the controller at any time and make adjustments to the haircut that is obtained.
